(19) United States
(12) Patent Application Publication
(10) Pub. No.: US 2009/0297798 A1
(43) Pub. Date: Dec. 3, 2009

(54) Feather-Filled Product Structure Without Stitches for Leak of Feathers Prevention

(76) Inventor: Yen-Sheng TSAI, Wugu Township (TW)

Correspondence Address: Troxell Law Office Pllc, Suite 1404, 5205 Leesburg Pike, Falls Church, VA, 22041, US

(21) Appl. No.: 12/131,369

(22) Filed: Jun. 2, 2008

(51) Int. Cl. B32B 7/10; A47G 9/08; A47G 9/00

(52) U.S. Cl. 428/200; 5/413 R; 5/502; 2/243.1

(57) ABSTRACT

The feather-filled product structure without stitches for leak of feathers prevention, includes a first cloth and a second cloth, with a hot melt adhesive being provided on a corresponding surface between the first cloth and the second cloth The first cloth and the second cloth can be joined when the hot melt adhesive has been molten. By the aforementioned structure, the first cloth and the second cloth can be joined together, and sewing holes produced after sewing can be filled by the hot melt adhesive after melting; therefore, cold air will not penetrate into, and feathers will not come out from the aforementioned feather-filled product

### BACKGROUND OF THE INVENTION

a) Field of the Invention

The present invention relates to a feather-filled product structure, and more particularly to a feather-filled product structure without stitches for leak of feathers prevention, so as to keep warm and avoid the feathers to come out.

b) Description of the Prior Art

As people need to protect from cold in cold winter days, they will have all kinds of goods to protect from cold. To have a better warm-keeping effect, people will put filling materials into the cold-protection goods, such as clothes, pants, sleeping bags and quilts, for increasing functions of warm-keeping and cold-protection. The filling material is usually divided into natural fiber and artificial fiber, and feather in the natural fiber will have the best cold-protection effect.

Why a feather-filled product can keep warm is due to that it is provided with an air-vent structure. Feather down itself is provided with millions of triangular nodes to absorb a large amount of air; and as air is not a good heat conductor, cold air can be prevented from quickly passing through and body temperature can be prevented from losing. Therefore, the feather-filled product has now been used widely as it is a kind of goods that is light in weight and provided with the function of cold-protection.

However, when using the aforementioned feather-filled product, following issue and shortcoming actually exist to be improved.

Referring to FIG. 1, it shows a three-dimensional cutaway view of a conventional feather-filled product 1. As feathers will usually be displaced by squeezing and compression of external force, they have to be fixed to prevent from being displaced. Hence, the feather-filled product 1 will be usually sewn through directly from outside, so as to partition an interior of the feather-filled product 1 into compartments for fixing the feathers without displacement. Nevertheless, due to sewing, a surface of the feather-filled product I will result in a lot of sewing holes, and a lot of cold air will pass through the sewn places where the feathers are thinnest, allowing the feather-filled product to have an imperfect warm-keeping effect. In addition, the feather fiber will pierce out from the sewing holes, thereby causing a major flaw in quality.

Accordingly, how to solve the aforementioned issue and shortcoming that the feathers will come out is a direction of research and development for improvement by the present inventor and related vendors.

### SUMMARY OF THE INVENTION

The primary object of the present invention is to provide a feather-filled product structure without stitches for leak of feathers prevention, wherein a hot melt adhesive is provided between a first cloth and a second cloth, such that after an internal of the feather-filled product has been made into compartments by sewing, the hot melt adhesive between the first cloth and the second cloth can be molten to fill sewing holes after the hot melt adhesive has been formed. By the aforementioned technology, the issue of the conventional feather-filled product that the feathers will come out can be broken-through, so as to achieve the practicability and progressiveness that the feathers will not come out.

Another object of the present invention is to provide a feather-filled product structure without stitches for leak of feathers prevention, wherein a hot melt adhesive is provided between a first cloth and a second cloth, such that after a layer of hot melt adhesive has been added between the first cloth and the second cloth, passing through of cold air can be cold air can be diminished, allowing the places where the feathers are the least to become less permeable to air. By the aforementioned technology, the issue of the conventional feather-filled product that the warm-keeping effect is imperfect can be broken-through, so as to achieve the practicability and progressiveness of warm-keeping.

Still another object of the present invention is to provide a feather-filled product structure without stitches for leak of feathers prevention, wherein a hot melt adhesive is provided between a first cloth and a second cloth, such that after the hot melt adhesive has been molten, the first cloth can be joined with the second cloth. In addition, when making the feather-filled product, only a simple handwork and a fusing machine are used instead that the hot melt adhesive is molten to make compartments, which is a revolutionary production, with a quick mass production being available without requiring a sewing skill. By the aforementioned technology, the present invention is provided with the advantage of quick production, thereby achieving the practicability and progressiveness that the conventional feather-filled product is in short of.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional cutaway view of a conventional feather-filled product.

FIG. 2 shows a three-dimensional cutaway view of a preferred embodiment of the present invention.

FIG. 2A shows a local blow-up diagram of FIG. 2.

FIG. 3 shows a first schematic view of a preferred embodiment of the present invention.

FIG. 3A shows a local blow-up diagram of FIG. 3.

FIG. 4 shows a second schematic view of a preferred embodiment of the present invention.

FIG. 4A shows a local blow-up diagram of FIG. 4.

FIG. 5 shows a first schematic view of an operation of a preferred embodiment of the present invention.

FIG. 5A shows a local blow-up diagram of FIG. 5.

FIG. 6 shows a second schematic view of an operation of a preferred embodiment of the present invention.

FIG. 6A shows a local blow-up diagram of FIG. 6.

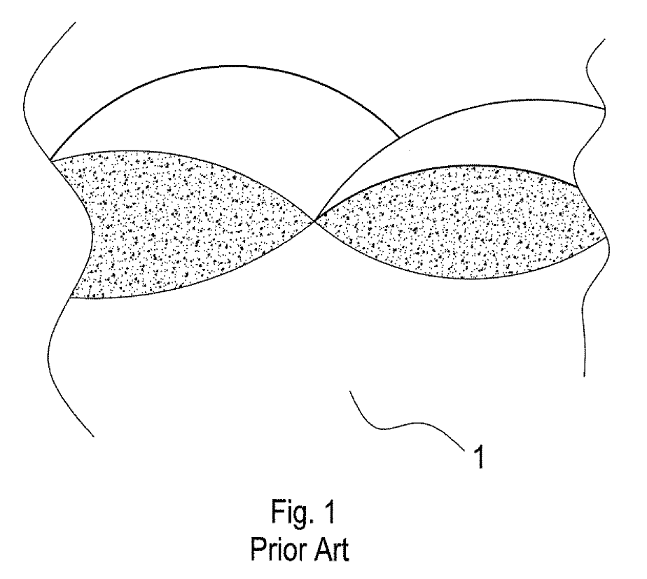

### DETAILED DESCRIPTION OF THE PREFERRED EMBODIMENTS

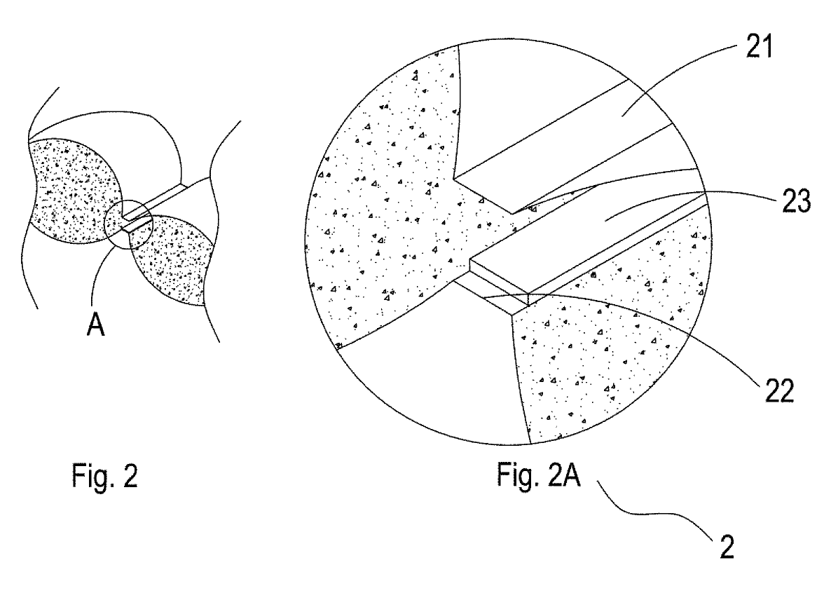

Referring to FIG. 2 and FIG. 2A, it shows a three-dimensional cutaway view of a preferred embodiment of the present invention and a local blow-up diagram of FIG. 2. A feather-filled product 2 of the present invention comprises a first cloth 21 and a second cloth 22, a containing space is provided between the first cloth 21 and the second cloth 22, and a corresponding surface between the first cloth 21 and the second cloth 22 is provided with a hot melt adhesive 23. After the hot melt adhesive 23 has been molten, the first cloth 21 can be joined with the second cloth 22, and the first cloth 21 and the second cloth 22 become less permeable to air. Moreover, the feather-filled product 2 can be a feather quilt, a feather sleeping bag, a piece of feather clothes and a pair of feather pants; whereas, the hot melt adhesive 23 can be in a sheet shape, a grain shape, a block shape or a stripe shape.

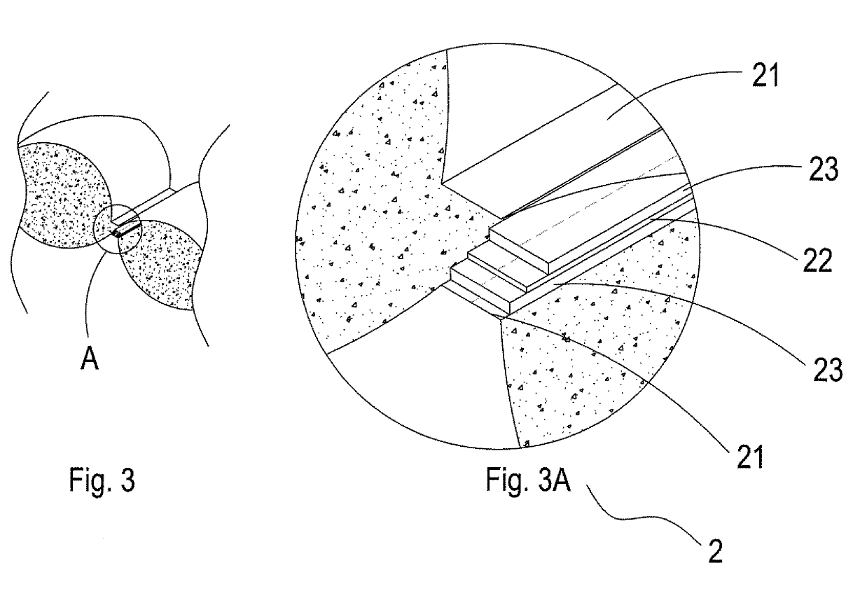

Referring to FIG. 3 and FIG. 3A, it shows a first schematic view of a preferred embodiment of the present invention and a local blow-up diagram of FIG. 3. The corresponding surface between the first cloth 21 and the second cloth 22 is provided with the hot melt adhesive 23, and below the second cloth 22 can be further added with a first cloth 21; whereas, a corresponding surface between this newly added first cloth 21 and the second cloth 22 is connected with a hot melt adhesive 23. When the first cloth 21, the second cloth 22 and the hot melt adhesive 23 are connected by sewing, the hot melt adhesive 23 is molten to join the first cloth 21 and the second cloth 22. Although the first cloth 21 and the second cloth 22 can be joined by sewing, sewing holes can be filled by the hot melt adhesive 23 after being molten and formed, such that feathers can not come out from those sewing places and cold air can be prevented from blowing in.

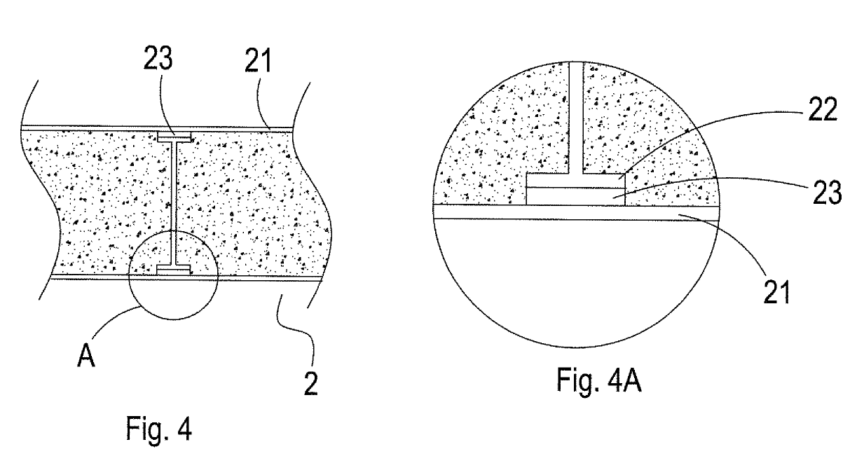

Referring to FIG. 4 and FIG. 4A, it shows a second schematic view of a preferred embodiment of the present invention and a local blow-up diagram of FIG. 4. The corresponding surface between the first cloth 21 and the second cloth 22 of the feather-filled product 2 is connected with the hot melt adhesive 23, wherein compartments are made to the feather-filled product 2 by the second cloth 22, and the second cloth 22 can be further formed as an I-shape structure by sewing cloth at two ends of the second cloth 22; this structure is more rigid. In addition, two end surfaces of the second cloth 22 are connected respectively with the hot melt adhesive 23, and each hot melt adhesive 23 is further connected to the first cloth 21. When making this feather-filled product 2, a simple handwork and a fusing machine can be used instead to melt the hot melt adhesive 23 at two end surfaces of the second cloth 22. This is a revolutionary production and a quick mass production is available to produce the internal compartments of the feather-filled product 2, without requiring a sewing skill. Accordingly, by the aforementioned structure, advantages of a quick production, reduced production cost and a more rigid structure can be achieved, without resulting in damage by stretching and pulling the feather-filled product 2.

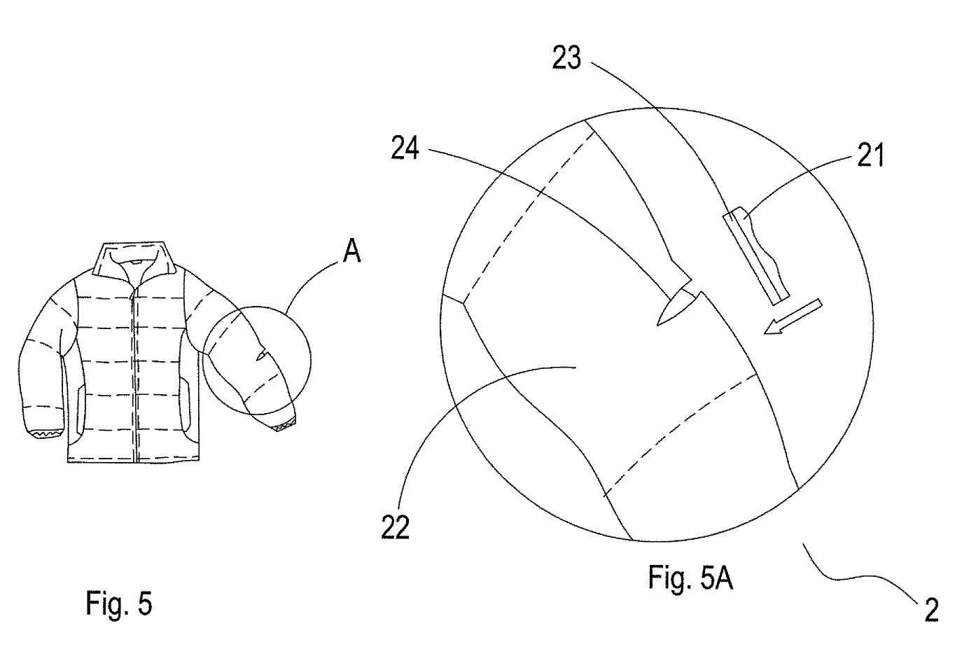

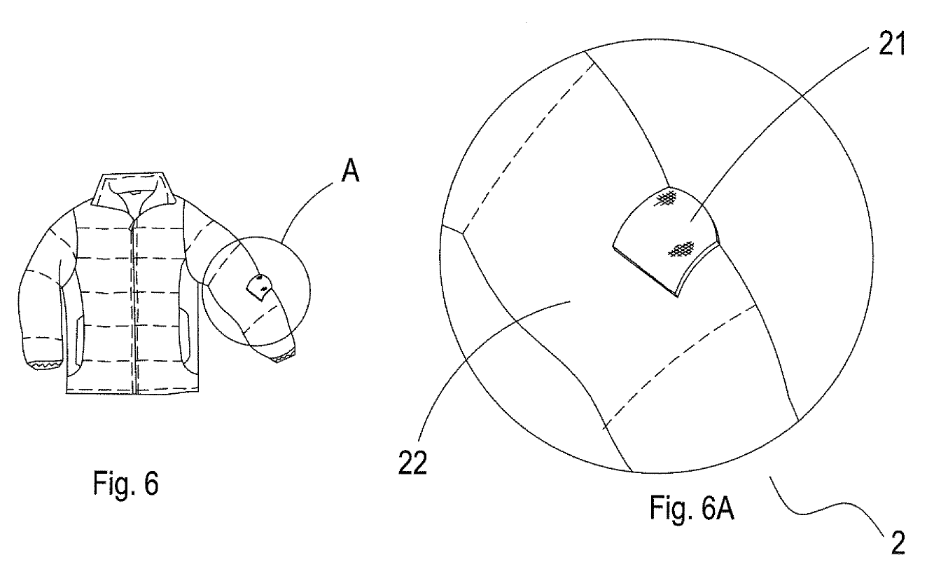

Referring to FIG. 5, FIG. 5A, FIG. 6 and FIG. 6A, it shows a first schematic view of an operation of a preferred embodiment of the present invention, a local blow-up diagram of FIG. 5, a second schematic view of an operation of a preferred embodiment of the present invention and a local blow-up diagram of FIG. 6. When the feather-filled product 2 needs to be filled with feathers, a surface of the feather-filled product 2 can be made into a hole 24 which can be used to fill the feathers. When the feathers have been filled completely, the first cloth 21 that is connected with the hot melt adhesive 23 is attached on the hole 24 on the second cloth 22 of the feather-filled product 2, and then the hot melt adhesive 23 is molten, such that by the feature of the hot melt adhesive 23, the hole 24 on the second cloth 22 of the feather-filled product 2 can be filled after melting the hot melt adhesive 23, thereby prohibiting the feathers in the feather-filled product 2 from dropping out. Therefore, effects that the feather-filled product 2 can be prevented from being restricted by a shape and a position of a tympan and the feathers can be filled at a proper location without tearing apart a piece of clothes can be achieved. Moreover, when the product has been used, the feathers to be filled can be increased or decreased according to requirements.

Referring to all the drawings, when using the present invention, following advantages exist actually in comparison with the prior art.

The feather-filled product 2 of the present invention is provided with the first cloth 21 and the second cloth 22, with the containing space being located between the first cloth 21 and the second cloth 22, and the hot melt adhesive 23 being provided on the corresponding surface between the first cloth 21 and the second cloth 22. By the aforementioned technology, the containing space between the first cloth 21 and the second cloth 22 can be partitioned into the compartments without sewing Hence, no sewing holes will be resulted, the product will be prettier, no feathers will drop out from the holes, and no cold air will enter into the product to provide the better warm-keeping effect; in a mean time, the fast production can be available and the dependence on the production skill of workers can be reduced.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A feather-filled product structure without stitches for leak of feathers prevention, comprising a first cloth and a second cloth between which is provided with a containing space, wherein a hot melt adhesive is provided between the first cloth and the second cloth, such that two corresponding surfaces of the first cloth and the second cloth are joined after the hot melt adhesive has been molten.

2. The feather-filled product structure without stitches for leak of feathers prevention, according to claim 1, wherein the feather-filled product is a feather quilt, a feather sleeping bag, a piece of feather clothes and a pair of feather pants.

3. The feather-filled product structure without stitches for leak of feathers prevention, according to claim 1, wherein the hot melt adhesive is in a sheet shape, a grain shape, a block shape or a stripe shape.

4. The feather-filled product structure without stitches for leak of feathers prevention, according to claim 1, wherein the second cloth is further formed as an I-shape structure by sewing cloth at two ends of the second cloth.
